(19) United States
(12) Patent Application Publication
(10) Pub. No.: US 2005/0234926 A1
(43) Pub. Date: Oct. 20, 2005

(54) Method to support authentication and authorization of web application user to database management system in web server based data-driven applications

(76) Inventor: Andrew Warner, Acworth, GA (US)

Correspondence Address: SCHIFF HARDIN LLP;Patent Department, 6600 Sears Tower, 233 South Wacker Drive, Chicago, IL, 60606, US

(21) Appl. No.: 11/103,032

(22) Filed: Apr. 11, 2005

Related U.S. Application Data
(60) Provisional application No. 60/561,347, filed on Apr. 12, 2004.

(51) Int. Cl. G06F 17/30

(52) U.S. Cl. 707/10

(57) ABSTRACT

A method for controlling access to a database management system includes permitting direct access only by a full user having a user name and password, for example. Light users must access the database management system through the full user. In an access authorization method, the web application user is authenticated to the database management system, the web application user is bound to a database management system session, an authentication request is accepted from a web user, which is forwarded to the database management system, upon successful authentication a secure database layer key for the database management system session is returned, the secure database layer key is associated with a user's web session and a data operation request is accepted from the web user; the data operation request and the secure database layer key are submitted to the database management system for execution and the results of the data operation to the web user, after which the web user is logged off and the secure database layer key invalidated.

### CROSS-REFERENCE TO RELATED APPLICATION

The present application claims the benefit of U.S. Provisional Patent Application Ser. No. 60/561,347, filed Apr. 12, 2004, which is incorporated herein by reference.

### BACKGROUND OF THE INVENTION

1. Field of the Invention

The present application relates generally to a method for controlling access to a database management system.

2. Description of the Related Art

Web based, data driven applications frequently use a three-tiered system architecture. The three tiers are the web browser, the middleware web application, and the database management system (DBMS). The web user interacting with the web browser submits operations to the middleware web application. The middleware web application authenticates and authorizes the web user and, if successful, submits operations to the DBMS. The middleware web application typically operates with permission to perform any DBMS operation on behalf of any web user. The middleware web application then returns results to the web user. The middleware web application typically services requests from many concurrent web users.

Web server based applications have been plagued by numerous well-publicized data security breaches. Web server based applications are characterized by:

1. The need to authenticate a user who does not have an actual account on the underlying DBMS, its host machine, or the web server host machine.

2. The need to perform database transactions at the privilege level of the web server application, rather than one tailored to the specific web application user.

3. The need to perform database transactions on data that may be critical or private to the web application user.

4. The need to protect each web application user from disclosure or tampering by other web application users.

5. The need to log all database transactions at the level of the web application user.

The problem of authenticating a web application user and the problem of binding that user's identity to the processing thread associated with the user (for example, the series of web pages they access) has been addressed with varying degrees of success. Since the Internet protocol, HTTP, is stateless, the binding of the web application user to the user's processing thread (at the application layer) requires functionality that has normally been associated with the operating system (OS) or the DBMS, and has been an attack vector in numerous web site intrusions.

Another problem with web applications is the fact that security decisions (for example, what rows of a table the user may access) are made within the domain of the web application rather than within the domain of the OS or DBMS. This is necessary because the OS and DBMS have no knowledge of the web application user, but only of the web application itself. Thus, all security decisions and all auditing are based upon the account under which the web application executes. Consequently, a web application, in performing a database transaction on behalf of a web application user, effectively delegates its full access privileges to that user, or anyone who manages to gain control of the web application. Hence, an error in the implementation of the web application permits the web application user to gain full access to the OS and DBMS.

Since the web application is authenticated, user identification is not formally passed to the DBMS, and the typical DBMS security mechanisms, such as discretionary access control (DAC), cannot be used to confine a user to a particular view of the controlled data. This compounds the hazards of implementing user authentication at the application layer, since doing so creates an access channel to the entire data domain of the web application for each web authenticated user.

Ad-hoc mechanisms implemented at the web application layer to control the web application user's view of the data have proven to be vulnerable to many types of attack, for example, dictionary attacks. In web enabled applications, the practical necessity of mediating all database interaction through the application layer, rather than through the OS or DBMS, masks the identity of the end user from the OS and DBMS. Consequently, security functionality and services traditionally supported by the OS and DBMS, such as user access permissions, user modification permissions, user specific rollback, and user specific logging and auditing, are exported from the OS and DBMS to the web application layer. This effectively reduces the DBMS to a dumb file server, and neutralizes its built-in security functionality. Hence, in the event of a successful attack, there is often no indication that an attack took place or the scope of the attack.

The solution of simply providing an OS or DBMS user account for every user has not been widely employed due to the overhead in establishing such accounts and the transitory nature of an individual user's interaction with the DBMS.

### SUMMARY OF THE INVENTION

The present invention provides a method and apparatus whereby an application, especially a web application, imposes a strong limitation on the view of a database that it makes available to an application user. This closes unintended data access channels in the application software. Hence, an attacker who defeats the security mechanisms at the application layer encounters stronger security mechanisms at the DBMS layer.

This method does not require the establishment of a separate DBMS account for each web application user, but permits web application users to share the web application's data connection, as is common practice.

### BRIEF DESCRIPTION OF THE DRAWINGS

FIG. 1 is a block diagram of users accessing a database management system; and

FIG. 2 is a functional block diagram of a secure database management system data operation.

### DETAILED DESCRIPTION OF THE PREFERRED EMBODIMENTS

Accessing security relevant, database resident information through a web application typically involves four distinct steps: authentication, data operation request, authorization, and data operation execution. During the authentication step, the web user presents identifying information (for example, user name) and secret information (for example, a password), and the web application confirms or denies the identity of the user. During the data operation request step, the authenticated user submits a request for an operation upon the database data. During the authorization step, the web application considers the user identity and the data operation request and decides if the user is authorized to perform the operation. During the data operation execution step, if the user is authorized to perform the operation, the operation is submitted to the database management system (DBMS), one example of which is Trusted RUBIX.

With traditional web applications, web users do not have DBMS accounts. This is due to the large number of potential web users, the overhead in creating and maintaining a DBMS account, and the potential security risks of giving web users direct account access to the DBMS. Therefore, web applications typically perform the authentication and authorization steps.

To implement the authentication and authorization steps, the web application is executed by a process with a DBMS account that has authorization to perform any potential valid data operation that may be submitted by any web user. In many cases, the web application also has authorization to perform data operations that would be considered illegal for a web user to perform.

In this traditional configuration, the web application has authorization with respect to the DBMS to perform all possible data operations. In turn, the web user has authorization with respect to the web application to perform the subset of data operations permitted for the particular user. The web application is trusted to properly perform the authentication, properly associate the correct web user identifier with all data operation requests (such as, bind the user ID with the user operation) and to properly decide if the data operation requested should be allowed or denied.

The sequence of steps a traditional web application performs follows:

1. Authenticate to the DBMS as the web application user. The DBMS will bind the web application user to DBMS session. This will give the web application the authorization on the DBMS to perform any needed data operation.

2. Accept an authentication request from a web user. Authenticate the web user by examining authentication data (using, for example, a password table) stored locally (for example, as a raw file) or in the database as a table under the control of the web application user (such as, SELECT * from password_table where user=username and password=userpassword).

3. Reject the user session, if the authentication is not successful. Otherwise, bind the authenticated user identifier to the user's web session (for example, session variables, cookies, URL). This will give the web user the authorization, on the web application, to perform data operations allowed for the particular user.

4. Accept a data operation request from the web user.

5. Authorize the web user to perform the operation. The particular Web application security policy is applied to the operation/web user ID to determine if the operation should be allowed. This determines if the web user is submitting a data operation request that falls within the subset of the operations allowed for that particular web user. If there is no bound user identifier associated with the user's web session, or the security policy check fails, the request is rejected.

6. Submit the data operation request to the DBMS for execution. The DBMS will authorize the web application user to perform the request based upon the DBMS session user ID (the web application user) and the data operation. The DBMS then performs the requested data operation.

7. Return the results of the data operation to the web user.

8. The web user logs out and the web user ID/web application session binding is removed from the web application.

This traditional approach of implementing the web user authentication and authorization in the web application (steps two and five), while the web application user operates with full trust, introduces serious security vulnerabilities. Briefly those vulnerabilities are:

1. If the web application process is “hijacked” by a malicious process, the malicious process has complete access to the data. This is because the web application runs with full trust on the DBMS.

2. If the web application is bypassed, the web application security policy is also bypassed.

3. If the web application has flaws in the implementation of its authentication, security policy, or user then the ID/session binding it will not be executed properly. This seems clear, but is actually rather serious, as web applications tend to be ad-hoc programs tailored to each particular web site's needs. Thus, the implementation of these security mechanisms tends to be deployed with little formal evaluation, and with little historical evidence that the security policy works properly in all circumstances.

4. If the security policy needs to be changed, the application itself is modified, which results in an increased probability of introducing errors.

The purpose of the present invention is to provide a method and apparatus, called a secure database layer (SDL), to remove the vulnerabilities of traditional web applications by providing one or more of the following: 1) providing functionality to authenticate web users; 2) strongly binding the web user ID with the DBMS session; 3) providing advanced security policy mechanisms, one example of which is Pviews (Policy Views which also control access to the database), to authorize the web user to perform the data operation requested; and, 4) implementing these features within a standardized DBMS.

The fundamental characteristics of the DBMS SDL mechanism are to move the authentication and user ID/session binding from the web application into the DBMS, and to use this binding to authorize the web user for data operations based upon a security policy. This removes the trust that is placed in traditional web applications and places it in the domain of the DBMS. This is preferred as a DBMS is designed to serve as an arbitrator of operations on data and has undergone more theoretical scrutiny. It is further preferred as there tends to be a single DBMS, but multiple web applications (for example, one per web site), resulting in a larger amount of historical evidence that the security policy is implemented properly.

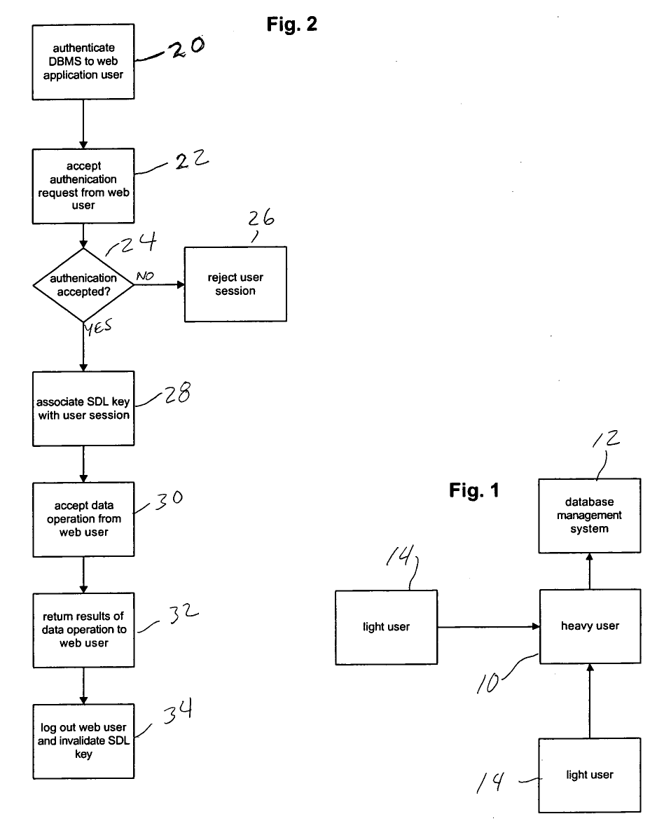

As shown in FIG. 1, there are two distinct types of users: “full users” and “light users”. A full user or heavy user 10 is analogous to a typical DBMS user. The full user is allowed to directly authenticate to and log into the DBMS 12. The attributes of the full user 10 (for example, a user having a user ID, group ID, privileges) are associated with the DBMS session upon logging in. The operations that a full user submits are controlled by the security policies of the DBMS 12. The security policies of the database management system can include DAC (Discretionary Access Control) which as its name implies, allows some discretion in who can access the database, or MAC (Mandatory Access Control) which is the strongest form of access control to the database.

A light user 14 is an entity that is dependent upon the privileges of a full user 10 to perform any DBMS operation. The light user 14 may authenticate to the DBMS 12, but may not log on. The light user 14 is not permitted to submit operations directly to the DBMS 12. Operations are submitted by the heavy user 10 on behalf of the light user 14.

A light user 14 is associated with exactly one full user 10, while a full user 10 may be associated with many light users 14. The full user 10 associated with the light user 14 must be logged onto the DBMS before a light user may authenticate or submit operations. The operations submitted on behalf of light users are restricted according to the privileges assigned to the corresponding full user 10. The light user operations are further controlled by a fine-grained, context sensitive security policy built upon the identity of the light user 14 and the data driven context of the operation.

The light user 14 is never allowed to submit operations unless the full user 10 is currently logged on. That is, only the specified full user 10 is allowed to submit operations on behalf of the light user 14. This prevents light users from bypassing the middleware. The full user 10 is also restricted so that it cannot submit operations unless a light user 14 is authenticated. This prevents a hijacking of the middleware process. When the proper full/light user combination is authenticated, any SQL operations submitted are restricted according to the intersection of the allowable SQL operations for the heavy user and light user.

Using the three-tiered Internet application architecture, the full user corresponds to the user executing the middleware application. The light user corresponds to the web user. The web application user corresponds to the full user.

When a DBMS SDL (secure database layer) mechanism is employed, the set of data operations allowed for any database table is the intersection of those allowed for the web application user and the web user. That is, the authorization of any data operation in the DBMS is calculated based upon the web application user ID, the web user ID, and the security policy. Effectively, the web application user and the web user are bound to the DBMS session. This results in the web application not being able to perform any data operation without a properly authenticated web user. This is because the authorization of the web user will fail. It also results in the web user not being able to perform any data operation without a properly authenticated web application user. This is because the authorization of the web application user will fail.

Referring to FIG. 2, the sequence of steps a DBMS SDL enabled web application performs includes:

1. Authenticate to the DBMS as the web application user as shown at 20. The DBMS will bind the web application user to the DBMS session. Since no web user is authenticated, the web application has no particular authorization.

2. Accept an authentication request from a web user at 22. Authenticate the web user, by submitting the authentication request to the DBMS. The DBMS will return an SDL (secure database layer) key, if the authentication is successful at 24. The SDL key is time sensitive and associated with the current DBMS session.

3. Reject the user session at 26, if the authentication is not successful. Otherwise, associate the SDL key with the user's web session (using, for example, session variables, cookies, URL and the like) as shown at 28.

4. Accept a data operation request from the web user at 30.

5. Submit the data operation request along with the associated SDL key to the DBMS for execution. The DBMS will authorize the data operation based upon the web application user ID (using various security policies), the web user ID (using the security policy), and the requested operation. The DBMS then performs the requested data operation.

6. Return the results of the data operation to the web user at 32.

7. Log out the web user and the SDL key is invalidated on the DBMS server at 34. At this point, the web application user can no longer perform any data operations because there is no authenticated web user. If the web user does not log out, the SDL key will expire after a configurable time period.

The DBMS SDL mechanism dramatically reduces the potential security vulnerabilities. Addressing the four vulnerabilities described above:

1. If the web application process is “hijacked” by a malicious process, the malicious process will, at most, have access to the subset of data operations allowed to currently authenticated web users. This access will be limited by the SDL session key timeout. If there are no authenticated web users, then the malicious process will have no access to the data operations. This is because the web application process requires the properly authenticated web user to perform data operations.

2. If the web application is bypassed, the security policy is not bypassed. This is because the security policy is implemented in the DBMS server.

3. If the web application has flaws in implementation, it will effect only the operation of the web site and not the security aspects of the web site.

4. If the security policy needs to be changed, the security policy is altered using well-defined interfaces and rules provided by the DBMS. The application need not be modified.

Although other modifications and changes may be suggested by those skilled in the art, it is the intention of the inventors to embody within the patent warranted hereon all changes and modifications as reasonably and properly come within the scope of their contribution to the art.

1. A method controlling access to a database management system, comprising the steps of:
classifying users as light users and heavy users;
associating a light user to a heavy user; and
connecting the light user to a database management system via a connection between the light user and the heavy user.

2. A method for authenticating a user of a database management system, comprising the steps of:
authenticate a web application user to a database management system;
bind the web application user to a database management system session;
accept an authentication request from a web user, said authentication request being forwarded to the database management system;
upon successful authentication, return a secure database layer key for the database management system session;
associate the secure database layer key with a user's web session;
accept a data operation request from the web user;
submit the data operation request and the secure database layer key to the database management system for execution;
return the results of the data operation to the web user;
log the web user off and invalidate the secure database layer key.

3. A method as claimed in claim 2, wherein the secure database layer key expires after a predetermined time and is limited to only one database management system session.

4. A method as claimed in claim 2, wherein said submitted data operation request is authorized based upon the web application user identification and on the web user identification.
